(19) United States
(12) Patent Application Publication
(10) Pub. No.: US 2018/0349373 A1
(43) Pub. Date: Dec. 6, 2018

(54) CONTROL OVER PROCESSES AND MACHINERY

(71) Applicant: Hand Held Products, Inc., Fort Mill, SC (US)

(72) Inventor: James Timothy Sauerwein, JR., Charlotte, NC (US)

(21) Appl. No.: 15/607,774

(22) Filed: May 30, 2017

(51) Int. Cl. G06F 17/30; G06F 3/01; G05B 19/042; G06F 1/16

(52) U.S. Cl. CPC G06F 17/30032; G06F 1/1686; G05B 19/0425; G06F 3/017

(57) ABSTRACT

A method for operating an industrial processes is described. An operator of the industrial process is observed by a camera. A gesture of the observed operator is recognized. A command based on the recognized gesture is generated by comparison of the recognized gesture to a database. The generated command is input to control logic operable for controlling the industrial process. A control function is exerted over the industrial process according to the command input. The industrial process is operated automatically based on the exerted control function without a touch-based operator input to a manual control device.

### TECHNOLOGY FIELD

The present invention relates generally to industrial control. More particularly, example embodiments of the present invention relate to controlling automated industrial processes and machinery.

### BACKGROUND

Generally speaking, industrial processes and machinery operate at high energy levels. Such high energy levels, upon exposure without confinement by design, construction, components, materials, and control, may present significant danger to life and limb. Thus, industrial processes and machinery are typically designed, built, and operated under control to prevent unprotected exposure to associated sources of high energy.

The sources of high energy associated with industrial processes and machinery may include, for example, high temperatures, pressures, electrical voltages, and levels of ionizing, optical, radio frequency (RF), and microwave radiation. Dangerous sources of high kinetic energy may also be associated with industrial processes and machinery. For example, industrial machinery may have heavy and/or sharp components and traction elements and other components moving at high speeds.

Reactive chemicals such as acids, oxidizers, and strong bases comprise yet another hazardous energy source in some industrial processes. Moreover, the chemical energy hazards of such materials may be exacerbated by high temperature and pressure associated with the process. Corrosiveness associated with such materials may damage or degrade machinery used in its processing. Toxicity associated with such materials may cause pollution if it escapes its confinement within a processing plant or container and is released to the environment. Some biochemical (and biological) materials associated with various processes may present other hazards, as well.

Unprotected exposure to high-energy sources may be deterred by protective coverings. For example, high voltage conductors may be insulated by high dielectric strength materials, shielded, armored, and/or installed at heightened elevations, within conduits, buried underground, encased within hardened structures, and/or confined within switchgear, locked electrical rooms, vaults, substations, and power plants.

The high-energy sources may also be ensconced within inaccessible enclosures associated with the industrial processes and machinery. For example, toxic or radioactive materials are typically confined to containers, vessels, pipes and other conduits, reaction chambers, pumps, valves and other machinery of a plant in which it is processed, which deters their release to the environment to prevent exposure, pollution and contamination.

The operation of industrial processes and machinery may be undertaken to maximize the safety of operators and other personnel, as well as the surrounding area. Industrial processes and machinery are typically operated under the control of skilled, trained operators and automation systems. Contemporary automated control systems may incorporate powerful and high-speed processing capabilities of digital computer systems for decision-making and implementing regulation over the processes and machinery. The automated control systems may be operable according to various user inputs.

Some of the user inputs to automated control systems may be as simple as actuating a ‘start’ switch to initiate an operation, or a ‘stop’ switch to stop the operation of a machine or industrial process. The start switch may be operable for completing a low voltage control circuit, for example, which thus energizes a solenoid coil to close a set of contacts and thus provide electrical power at a much higher voltage level to an electrical motor for driving a mechanical load.

Likewise, the stop switch may be operable for breaking the low voltage control circuit and de-energizes the coil, which thus opens the set of contacts and interrupts the flow of electrical current at the higher voltage to the motor. The motor may then slow to a stop under the mechanical load. An ‘emergency stop’ switch may also take this same action, and also be operable for triggering a brake mechanism to halt the motor and its load suddenly, without any significant delay.

More sophisticated or complex levels of control may be provided by other automated systems. Computer based automation provides programmability, scalability, precision, redundancy, high speed, real time processing, adjustments and updates, networking, and other capabilities to the automated control of industrial processes and machinery. Moreover, the capabilities of the computer based automated control may enhance the safety of the industrial processes and machinery in relation to the associated sources of high energy.

Computerized control systems typically comprise a user interface (UI) operable for receiving inputs from the operators in relation to data entries, addresses, selections, queries, programming, instructions, commands, and other information relevant to operational control.

Some UI approaches are under development or being adapted to utilize ‘gestures’ as inputs to computing systems. As used herein, the term ‘gesture’ refers to a movement, or a gesticulation, of a hand or head (or other body parts) of an operator in relation to signifying an input to a computer or other automated control system. Some gesture inputs may be made without direct contact between the gesturing body part of the operator and an input mechanism.

While some gesture-based inputs may be made thus “touchlessly,” they typically require at least some measure of proximity to the triggering device sufficient to effectuate a successful haptic related input. For example, a graphical user interface (GUI) may comprise a touchscreen display operable for rendering graphically an input receiver, such as a “radio” button. The radio button may be rendered over a portion of a viewing surface of the display operable haptically, or using a ‘mouse’ (or similarly translationally capable) interface for receiving a selection or command corresponding to a user input.

The graphic input receiver may be sensitive to haptic touch-based inputs. Conventional haptic touchscreen inputs comprise pressure applied directly to a touch-sensitive surface of the display, which are sensed by the conductor grids to effectuate a signal that corresponds to the input.

While the gesture-based inputs may, in one sense, be touchless, they typically still comprise gesticulations of the operator's body part(s) made in sufficient proximity to the touchscreen surface to trigger local variations in one or more electrical characteristics of the touchscreen significantly enough to effectuate the corresponding input. These proximity strictures tend to negate the isolation of the operators from the high-energy sources of the industrial processes and machinery, which touchless inputs may otherwise make available.

It would therefore be useful to mitigate operator exposure to hazards related to sources of high energy associated with industrial processes and machinery. It would also be useful to provide a gesture based UI operable touchlessly for inputting signals to an automated control system associated with the industrial processes and machinery safely, which avoids exposing the operators to the high-energy related hazards thereof. Further, it would therefore be useful to input the control signals independent of close proximity to the UI.

### SUMMARY

Accordingly, in one aspect, an example embodiment of the present invention embraces a method for providing an input to a control system that mitigates operator exposure to hazards related to sources of high energy associated with industrial processes and machinery. An example embodiment relates to a gesture based UI operable touchlessly for inputting signals to an automated control system associated with the industrial processes and machinery, which avoids exposing the operators to the high-energy related hazards thereof. Example embodiments may be implemented that are operable for inputting the control signals independent of close proximity to the UI.

A method for operating an industrial processes is described. An operator of the industrial process is observed by a camera. A gesture of the observed operator is recognized. A command based on the recognized gesture is generated by comparison of the recognized gesture to a database. The generated command is input to control logic operable for controlling the industrial process. A control function is exerted over the industrial process according to the command input. The industrial process is operated automatically based on the exerted control function without a touch-based operator input to a manual control device.

In another aspect, example embodiments of the present invention embrace a control system. In an example embodiment, a system for controlling an industrial process and/or machinery comprises a gesture recognizing user interface (GRUI) operable for observing an operator of the automated industrial process/machinery, and for recognizing a gesture of the observed operator.

The gesture is recognized as comprising a particular gesture of a plurality of operator gestures. Each of the multiple gestures corresponds uniquely to a particular control input operable for the controlling of the automated industrial process/machinery.

The control system also comprises a command generator. The command generator is operable for generating a command gesture based on the recognized gesture. The generated command relates to initiating the particular control input corresponding uniquely to the recognized particular gesture of the observed operator.

Further, the control system comprises a drive logic operable for initiating the control input and thus, for controlling the process/machinery, according to the generated command.

In yet another aspect, example embodiments of the present invention embrace a non-transitory computer readable storage medium. An example embodiment relates to a non-transitory computer readable storage medium comprising instructions, which when executed by a processor are operable for, controlling an automated industrial process and/or machinery according to a method, such as the control method summarized above.

The foregoing illustrative summary, as well as other example features, functions and/or aspects of embodiments of the invention, and the manner in which the same are accomplished, are further explained within the following detailed description of example embodiments and each figure (“FIG.”) of the accompanying drawings.

### BRIEF DESCRIPTION OF THE DRAWINGS

FIG. 1 depicts a flowchart of an example process for exerting gesture based control over an industrial process and/or machinery, according to an embodiment of the present invention;

FIG. 2 depicts a flowchart for an example process relating to safety related gesture recognition and command generation, according to an embodiment of the present invention;

FIG. 3 depicts a flowchart for an example process relating to operator specific gesture recognition and command generation, according to an embodiment of the present invention;

FIG. 4 depicts an example system for controlling an industrial process and/or machinery, according to an embodiment of the present invention;

FIG. 5 depicts an example gesture recognizing user interface (GRUI), according to an embodiment of the present invention;

FIG. 6 depicts an example input initiator, according to an embodiment of the present invention; and

FIG. 7 depicts an example computer network, according to an embodiment of the present invention.

### DESCRIPTION OF EXAMPLE EMBODIMENTS

Example embodiments of the present invention are described in relation to methods and systems for controlling an industrial processes and/or machinery. A method for operating an industrial processes is described. An operator of the industrial process is observed by a camera. A gesture of the observed operator is recognized. A command based on the recognized gesture is generated by comparison of the recognized gesture to a database. The generated command is input to control logic operable for controlling the industrial process. A control function is exerted over the industrial process according to the command input. The industrial process is operated automatically based on the exerted control function without a touch-based operator input to a manual control device.

Example embodiments of the present invention thus provide inputs to a control system that mitigates operator exposure to hazards related to sources of high energy associated with industrial processes and machinery. An example embodiment relates to a gesture based UI operable touchlessly for inputting signals to an automated control system associated with the industrial processes and machinery, which avoids exposing the operators to the high-energy related hazards thereof. Example embodiments may be implemented that are operable for inputting the control signals independent of close proximity to the UI.

Overview.

An example embodiment of the present invention relates to a method for controlling an industrial process and/or machinery. A method for operating an industrial processes is described. An operator of the industrial process is observed by a camera. A gesture of the observed operator is recognized. A command based on the recognized gesture is generated by comparison of the recognized gesture to a database. The generated command is input to control logic operable for controlling the industrial process. A control function is exerted over the industrial process according to the command input. The industrial process is operated automatically based on the exerted control function without a touch-based operator input to a manual control device.

Example embodiments of the present invention thus provide gesture based command inputs directly to safety related and automated control systems, which control processes and/or machinery in various industrial environments.

For example, a gesture recognition system may be coupled communicatively to drive logic on automated robotic equipment. Commands based on the recognized operator gestures are communicated as data signals to the drive logic. The gesture recognition system is operable for observing an operator of the process/machinery.

For example, one or more stations in which the operator may be located, situated, positioned, and/or moving may be monitored within the optical field of view (FOV) of a camera or other observation component of the gesture recognition system. The camera is operable for providing a corresponding real time video data stream, feed, or signal related to the monitored observations. The gesture recognition system is programmed and operable for recognizing a gesture, such as an open outward facing palm extended by an operator's gesticulation, as a signal to the drive logic. Based on recognition of the extended palm gesture, the gesture recognition system may generate corresponding commands related to implementing an ‘emergency stop’ control action over the process/machinery.

Other commands may correspond to other operator gestures. For example, the gesture recognition system may track a rotating hand gesture by an observed operator. The hand rotation gesticulation may be recognized as a gesture to begin a process operation, or to start a particular machine or machinery line, and generate a corresponding ‘start’ command. Signals corresponding to the generated start command are communicated to the drive logic, which controls the robotic equipment to commence the operation accordingly. The present ‘emergency stop’ and ‘start’ commands may represent any kind of operator gestures with which the gesture recognition system may operate.

As with any recognized gestures, example embodiments of the present invention allow the operator to control the industrial process and/or machinery from a remote position. The remote position may correspond to a safe location in which the operator station may be disposed. Example embodiments thus mitigate operator exposure to hazards related to sources of high energy associated with industrial processes and machinery. The operators could otherwise be exposed to the hazards, if the commands were to be made by conventional means, such as for actuating light curtains or proximity sensors sometimes used with industrial processes and machinery.

An example embodiment of the present invention relates to a method for exerting gesture-based control over an industrial process and/or machinery. As used herein, the term “machinery” may refer generally to a plurality of machines, to one or more particular machines, and/or to machines associated with an industrial plant operable using the machines for performing one or more industrial processes. In an example embodiment of the present invention, a computer-implemented method is operable for controlling industrial processes and/or machines.

Example Method for Gesture based Industrial Control.

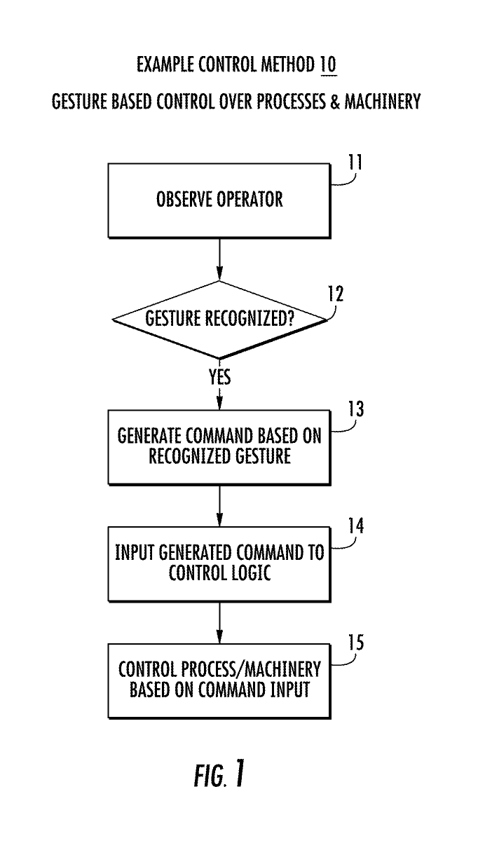

FIG. 1 depicts a flowchart of an example computer implemented method 10 for exerting gesture-based control over an industrial process and/or machinery, according to an embodiment of the present invention.

In step 11, an operator of the industrial process/machinery is observed within a FOV of a camera (or other observation component) of a gesture recognition functionality.

In step 12, a decision is made in relation to recognition of a gesture made by the operator. If no operator gesture is recognized, then the method 10 loops back to step and continues observation of the FOV. If an operator gesture is recognized, then the method 10 proceeds to step 13.

In step 13, a command, relating to control over the industrial process/machinery, is generated based on the recognized gesture.

In step 14, the generated gesture based command is provided as an input to control logic operable for controlling the industrial process/machinery.

In step 15, a control function is exerted over the industrial process/machinery according to the generated command input.

The recognizing step 12, the generating step 13, the input step 14, and/or the exerting step may relate to a safe operation of the industrial process/machinery. For example, the safe industrial process or machinery operation may relate to stopping the process or the machine.

Example Safety-Related Gesture Based Commands.

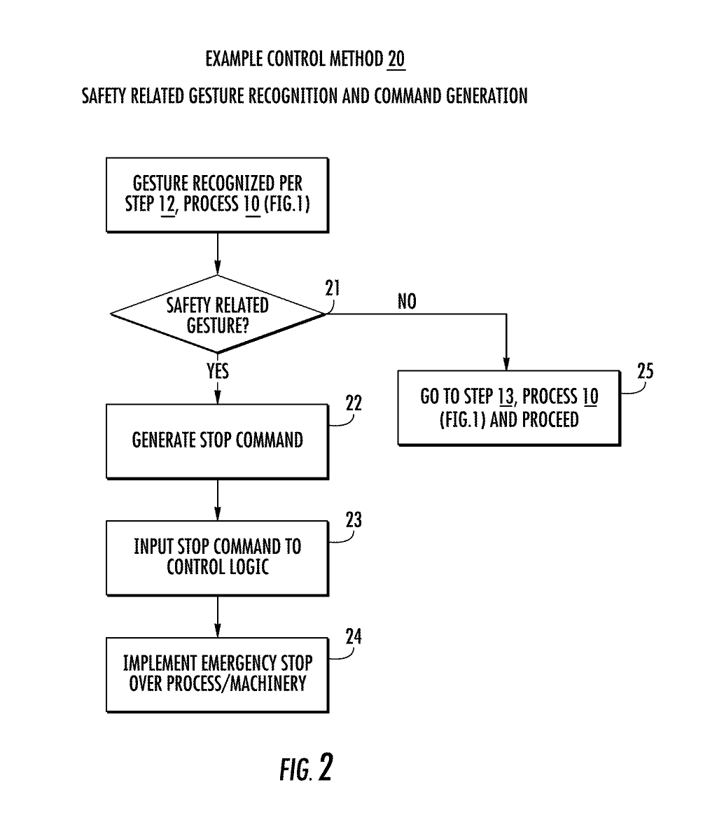

FIG. 2 depicts a flowchart for an example computer implemented control method 20 relating to safety related gesture recognition and command generation, according to an embodiment of the present invention. In step 21, a determination is made whether the operator gesture recognized at step 12 of process 10 (FIG.1) is related to a safe operation of the process and/or machinery (“safety related”).

If not, then in step 25, method 10 proceeds (at step 13; FIG.1). For example, it may be determined that the gesture, e.g., a rolling hand motion gesticulation of the operator, corresponds to a signal for starting the process/machinery.

It may be determined, however that the recognized operator gesture is safety related. For example, it may be determined that the gesture, e.g., an extended palm, the extended palm gesticulating from side to side, and or an extended and/or pumped first gesticulation of the operator, corresponds to a signal for stopping the process/machinery. If so, then in step 22, a corresponding ‘stop’ command is generated.

The safety related stop signal may relate to the stoppage of the process/machinery independent of (e.g., without) any intentional delay. In this case, the safety related stop signal may comprise an ‘emergency stop’ signal.

A stop command corresponding to the emergency stop signal may trigger an engagement of a mechanism, means or modality operable for braking the machinery in-place or suddenly, and/or blocking and/or interrupting, and if appropriate, shunting, venting, containing, and/or extinguishing, safely, the source(s) of energy used in sustaining the process and/or energizing the machinery, or presented by a feature associated with the process/machinery.

Example Operator-Specific Gesture Based Commands.

The safe operation of the industrial process/machinery may relate to a restricting of an implementation of the generating step 13, the inputting step 14, and/or the exerting step (15) in relation to an authority of the operator corresponding thereto. For example, certain training and reliability related operator qualifications may be significant to safe operations of the process/machinery. An example embodiment restricts the control over the process/machinery to operators authorized based on achieving a prerequisite qualification level and/or reliability certification. The restriction may comprise querying an associated operator authority related database.

The authority database may comprise a relational database operable for pairing, relationally, an identity of each of a plurality of authorized candidate operators and a corresponding unique authority level in relation to the controlling of the automated industrial process or machine.

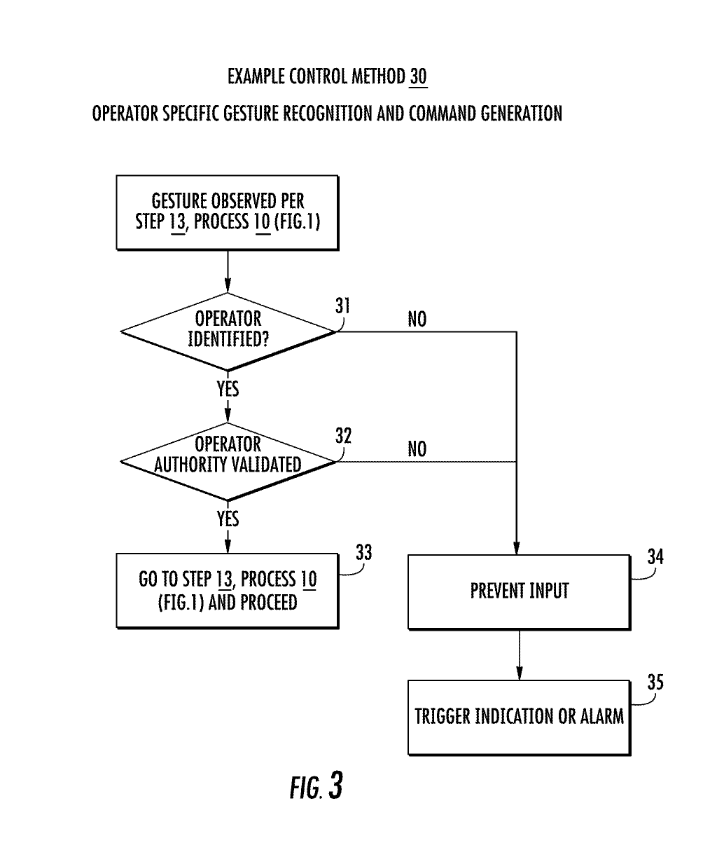

FIG. 3 depicts a flowchart for an example computer implemented method 30 relating to operator specific gesture recognition and command generation, according to an embodiment of the present invention.

In relation to the gesture observed at step 13 of process 10 (FIG.1), it is determined in step 31 whether the operator making the gesture may be identified. For example, the operator authority database may be queried in relation to the observed operator. Based on the query, the observed operator may be identified in relation to the plurality of authorized candidate operators.

If the operator is identified, then it is determined in step 32 (e.g., also based on the query) whether an authority level of the identified operator is positively valid in relation to the controlling of the automated industrial process or machine.

If the authority level of the identified operator is positively valid in relation to the controlling of the automated industrial process or machine, then in step 33, process 10 may proceed at step 13 (FIG.1).

On the other hand, if the identity of operator in relation to the plurality of operator candidates, and/or the identity of the identified operator in relation to the corresponding validated unique authority level, then in step 34, a signaling of the command generator in relation to the particular control input is presented.

Moreover, an enunciator operable for triggering a corresponding alarm or indication may be signaled in step 35.

An example embodiment of the present invention relates to a non-transitory computer readable storage medium comprising instructions, which upon execution by one or more computer processors, are operable for controlling one or more of an industrial process or machine according to the methods 10, 20 and/or 30.

The methods 10, 20, and/or 30 may be performed or implemented by a computer-based system for controlling one or more of an automated industrial process or machine.

Example Gesture Based Control System.

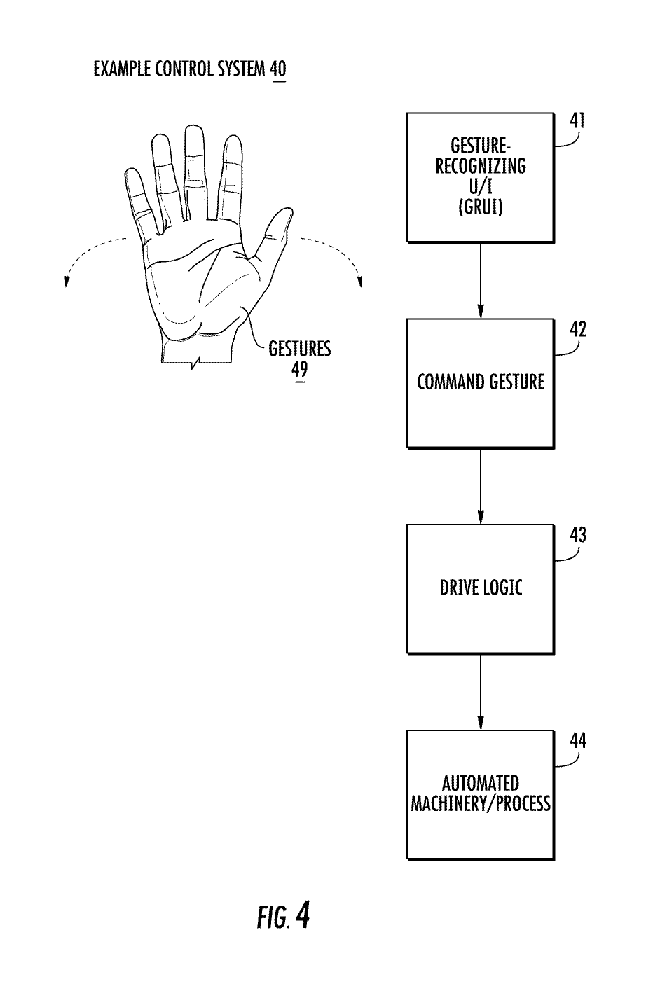

FIG. 4 depicts an example computer-based system 40 for controlling a process/machinery, according to an embodiment of the present invention. The control system 40 is operable for performing or implementing one or more steps of the methods 10, 20, and 30 (FIG.1, FIG.2, and FIG.3, respectively).

The control system 40 comprises a gesture-recognizing user interface (GRUI) 41. The GRUI 41 is operable for recognizing a gesture 49 of an operator of the automated industrial process or machine 44 as a particular gesture of a plurality of operator gestures. Each of the plurality of gestures corresponds uniquely to a particular control input operable for the controlling automated industrial process/machinery 44.

A command generator 42 is operable for generating a command operable corresponding to the recognized gesture 49 and for providing an input to a drive logic 43 based on the generated command. The command relates to initiating the particular control input that corresponds uniquely to the particular recognized gesture 49 of the operator.

The drive logic 43 is operable for the controlling of the automated industrial process or machine 44 based on the generated command. A function, operation, and/or action of the process/machinery 44 is implemented, regulated, altered, adjusted, inhibited, stopped, and/or otherwise controlled according to the operation of the drive logic 43.

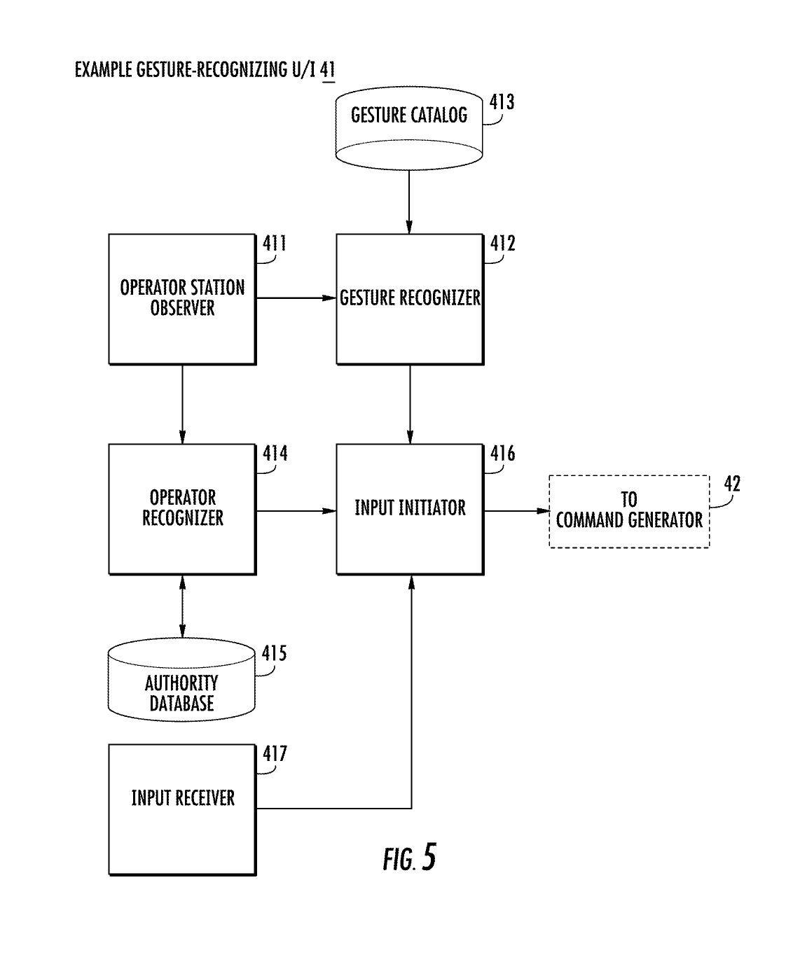

FIG. 5 depicts an example GRUI, according to an embodiment of the present invention. The GRUI 41 may comprise an observation component 411, a gesture recognition component (“gesture recognizer”) 412, and an input-initiating component (“input initiator”) 416. The observation component 411 is operable for observing the operator and the operator gesture 49.

An example embodiment may be implemented in which the observation component 411 comprises a camera device (“camera”). The camera 411 is operable for the observation of the operator gesture 49 and providing a real time video data stream, which comprises data relating to the observed the operator gesture 49.

The gesture recognizer 412 is operable for recognizing the observed operator gesture 49 as corresponding to the particular control input. The gesture recognizer 412 is also operable for informing the input initiator 416 in relation to the particular control input.

The GRUI may also comprise a gesture catalog 413. The gesture catalog 413 comprises a relational database, which pairs, relationally, each of the plurality of operator gestures and a particular control input corresponding to the gesture. For example, one of the gestures may be paired, and thus inferred by the gesture catalog 413 as intended to comprise an input associated with, a particular control function to be exerted over the automated process/machinery 44. The gesture database 413 may be preloaded with a catalog of standard gestures. For example, images of various generic human hands may be preloaded into the gesture catalog 413. The generic human hands may comprise images of bare hands, gloved hands, left and right hands, fronts and backs of hands, hands from a variety of vertical and horizontal angles, flash and prosthetic hands, open hands, fists, etc. Corresponding images of various individual hands may also be imaged and loaded into the gesture catalog 413. The images stored in the gesture catalog 413 may comprise moving images of the hands. For example, the gestures may comprise an open hand, waving from side to side, or of a closed fist pumping up and/or down, and/or moving quickly. These images may be relationally associated with control inputs related to implementing a ‘stop’ and/or ‘emergency stop’ and operating the industrial process or machinery to stop, and/or stop without any intentional delay, and for example, a sudden braking action, an extinguishing of a combustion, a curtailment of a chemical reaction, a stoppage or curtailment of a temperature rise, a valve closure (or opening), etc. to be applied thereto. Gestures may also comprise images of hands and/or one or more fingers of hands, certain numbers of fingers, fingers extended, twirled, or otherwise moved in various directions, and/or moved at certain speeds etc. Each stored gesture may be associated relationally in the gesture catalog 413 with a corresponding control function, which may be exerted based on the gesture over a particular operation of the industrial process or machine. In addition to preloading the gesture related images, the gesture catalog 413 may be extended and/or revised by local programming related to recording, modifying, revising, deleting, re-associating, or augmenting the gesture related images.

The recognition of the observed operator gesture 49 may comprise a query input made to the gesture catalog database 413 by the gesture recognizer 412, and a corresponding response to the query. The query response may positively identify the observed operator gesture 49 as corresponding to a particular control input intended to be exerted over the automated process/machinery 44. Upon receiving a positive return that identifies the control input corresponding to the query, the gesture recognizer 412 informs the input initiator 416 accordingly. In the event of the query returning a null or negative response to the query, the gesture recognizer may simply remain silent in relation thereto.

For example, the operator may be observed to change their stance, stretch, run their hand through their hair, scratch an itch, adjust their clothing, retrieve or replace an item in their pocket, or wipe with a wiping rag (e.g., for cleaning to remove machinery lubricating oil residues or leakage, dust, mung, grime, and/or other contaminants) or engage in a similar workaday, practical and/or bodily comfort related action. The gesture recognizer 412 may thus be operable for filtering such observations of the operator as insignificant in relation to the control over the process/machinery 44, and thus ignore that observation as negative or null, etc., in relation to control related gestures. For such ignored observations of the operator, the gesture recognizer 412 may thus remain silent in relation to informing the input initiator 416.

The input initiator 416 is operable for signaling the command generator 42 in relation to the particular control input based on the recognized corresponding particular gesture 49.

The GRUI further may comprise an operator recognizer 414 and an operator authority database 415. The operator authority database 415 pairs, relationally, an identity of each of a plurality of authorized candidate operators and a corresponding unique authority level in relation to the controlling of the automated industrial process or machine 44. The authorized candidate operators may comprise operator, maintenance, and supervisory personnel authorized, each at various corresponding levels of authority, for implementing control over the process/machinery 44.

The recognizing the observed gesture may comprise the operator recognizer 414 querying the operator authority database 415 in relation to the observed operator. Based on the query, the operator recognizer 414 ascertains an identity of the observed operator in relation to the plurality of authorized candidate operators.

Based further on the query, a validation is performed in relation to the unique authority level corresponding to the identified operator. The validation comprises verifying that the identified operator has, positively, the authority to initiate the control over the automated industrial process or machine 44 associated with the recognized input corresponding to the observed gesture 49 of the operator.

The operator recognizer 414 is operable for informing the input initiator 416 in relation to the positive validated unique authority level corresponding to the identified operator. The input initiator 416 is operable, uniquely upon receiving the information relating to the positive validation, for the signaling the command generator 42.

An example embodiment may be implemented in which, absent the positive operator authority validation, the input initiator 416 will not signal the command generator 42 and thus, prevents generation of a command in response to the observed gesture 49 and unauthorized control over the process/machinery.

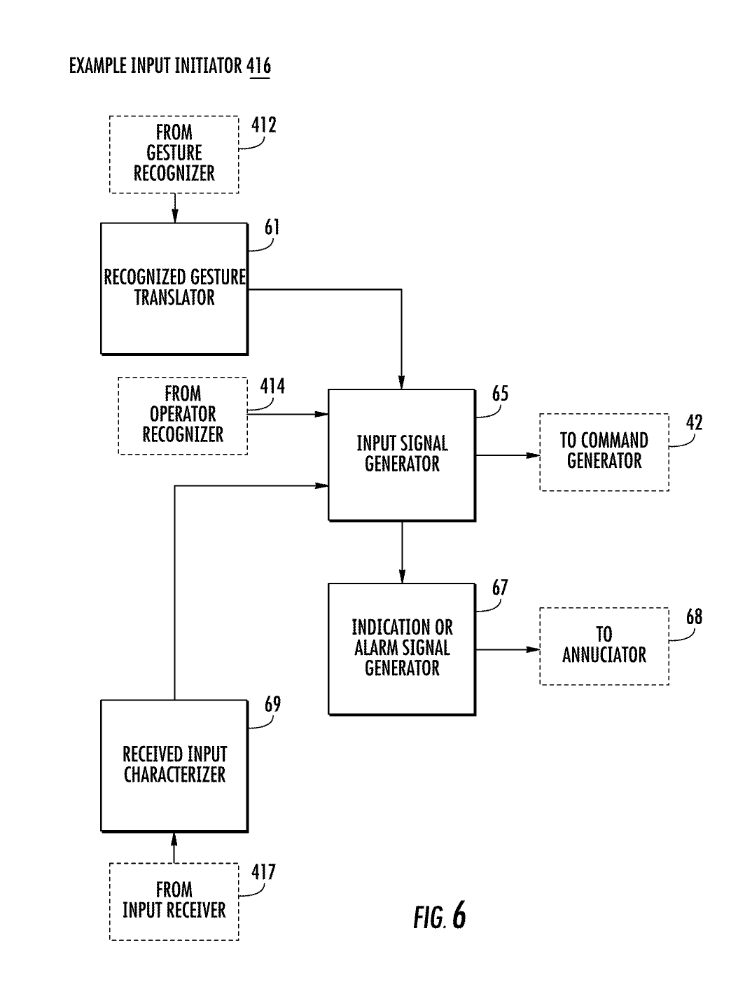

FIG. 6 depicts an example input initiator 416, according to an embodiment of the present invention. The input initiator 416 may comprise an input signal generator 65 and a recognized gesture translator 61. The recognized gesture translator 61 is operable for receiving the information from the gesture recognizer 412 (FIG.5) in relation to the particular control input corresponding to the observed operator gesture 49.

Further, the input signal generator (“input signaler”) 65 is operable for receiving the information from the operator recognizer 412 (FIG.5) relating to identifying the operator making the gesture 49, and validating the authority level of that operator, positively, to control the process/machinery 49 according to the recognized gesture. The input initiator 416 may also comprise an ‘indication/alarm’ signal generator 67.

Negative information may also be received, however, from the operator recognizer 414 (e.g., based, further based on the query) in relation to the identity of the operator making the gesture 49 (e.g., as to the plurality of operator candidates, and/or the identified operator in relation to the corresponding unique authority level). The input signaler 416 may be further operable for preventing control over the process/machinery 49 based on the observed gesture 49.

For example, upon receipt of the negative authority related data, the input signaler 416 may be operable for preventing the GBUI 41 from signaling the command generator 42 in relation to the particular control input corresponding to the observed gesture 49. The input signaler 65 may also be operable for signaling an indication or alarm signal generator to signal an annunciator 68. The annunciator 68 is operable for triggering an indication or alarm corresponding to the negative validation information associated with the operator candidate making the observed gesture 49.

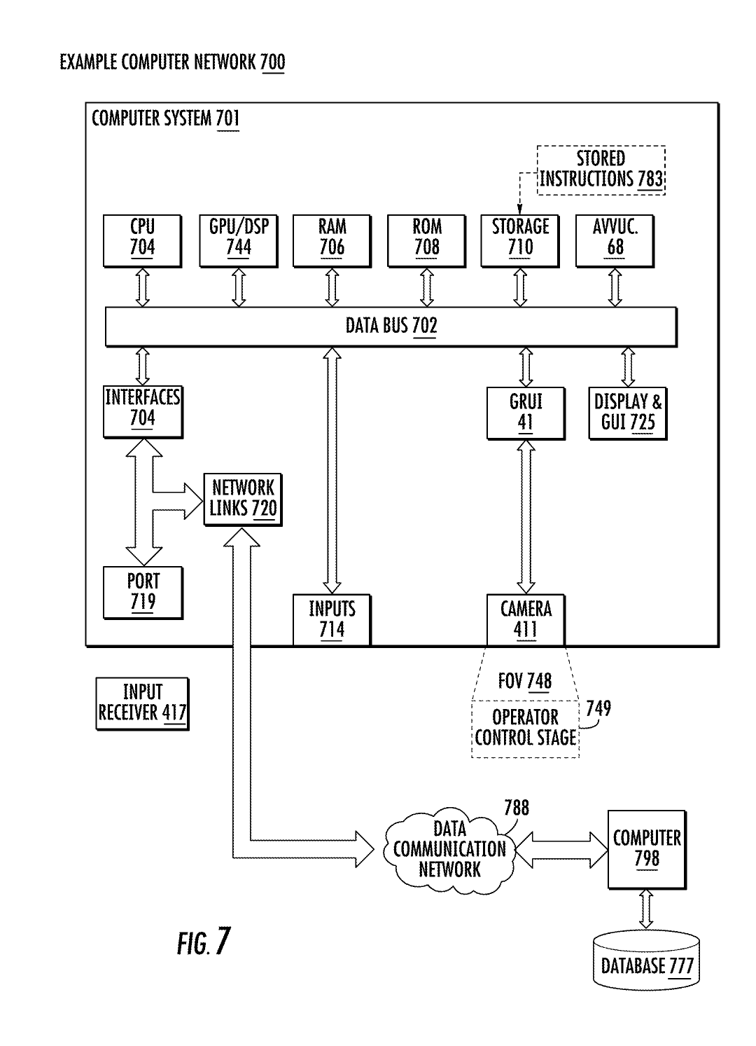

With reference to FIG. 6, and again to FIG. 5, the GRUI 41 may also comprise one or more input receivers 417. The input receivers 417 may comprise a GUI (e.g., GUI 725; FIG.7), electrical, electromagnetic, electromechanical devices such as ‘stop’ and ‘start’ switches, valve ‘open’, ‘close’ and intermediate positioning actuators, etc., and/or electronic devices such as process controllers and/or ‘readers’ of radio frequency identification (RFID) and one dimensional (1D) and two dimensional (2D) graphic and/or geometric data patterns (e.g., bar codes and data matrix patterns), etc. One or more of the input receivers 417 may be operable for receiving inputs via a network or external device (e.g., network 788, external device 799; FIG.7).

An example embodiment may be implemented in which the input initiator 416 comprises a received input characterizer 69. The received input characterizer 69 is operable for receiving a control input to the process/machinery 44 from the input receiver 417. The received input characterizer 69 is operable for informing the input signal generator 65 in relation to the inputs received by the input receiver 417. Example embodiments of the present invention may thus allow or support inputs to the process/machinery 49 that may be other than gesture based.

An example embodiment of the present invention relates to a method for programming a control over an industrial process. The programming method comprises establishing one or more commands, each related to an activation of a corresponding a control function over an aspect of the industrial process. A plurality of images is stored in a database.

The images relate to one or more gestures, which are each presentable with a particular motion of a portion of a body of one or more human operators of the industrial process. In the database, an addressable corresponding relationship is associated between each of the gestures and a specific one of the established commands.

Using a camera during an operation of the industrial process, at least one of the human operators is observed. A movement of the portion of the body of the observed at least one operator is sensed. The database is queried in relation to the sensed movement. Responsive to the querying, it is recognized that the sensed operator body part movement corresponds to the particular motion associated with the particular established command.

A controlling input to the industrial process is asserted, which corresponds to the recognized associated established command. The control over the industrial process is activated based on the asserted controlling input. The activated control is imposed over the industrial process independent of any actuation exerted with zero or more manual, manual-electric, or automatic controllers, which may be operable parallel to the programming steps.

Example Computer Network.

FIG. 7 depicts an example computer network 700, according to an embodiment of the present invention. The computer network 700 comprises a first computer system (“computer”) 701 and a data communication network 788.

The network 788 may comprise a packet-switched data network operable based on transfer control and internetworking protocols (e.g., TCP/IP). The computer 701 may be coupled communicatively, and exchange data signals, over the data communication network 788 with at least a second computer 798 may be coupled communicatively via the data network 788. The data network 788 may comprise a portion of one or more other networks and/or two or more sub-network (“subnet”) components. For example, the data network 788 may comprise a portion of the internet and/or a particular wide area network (WAN). The network 788 may also comprise one or more WAN and/or local area network (LAN) subnet components. Portions of the data network 788 may be operable wirelessly and/or with wireline related means. The data network 788 may also comprise, at least in part, a digital telephone network.

The computer 701 may comprise the GRUI 41 and the camera 411. The camera 411 is operable for observing the operator control station 749, which is within the optical FOV 748 of the camera. The camera provides a real time video feed to the GRUI 41. The video feed comprises data corresponding to the observation of the operator station, which may comprise observing an operator making the gesture 49 (FIG.4). The GRUI processes the video feed, e.g., according to In addition to the control methods 10, 20 and 30 (FIGS. 1, 2 & 3, respectively).

An example embodiment may be implemented in which the computer 701 may be operable for sending data to the computer 798 in relation to the observations of the operator station over the data network 788. The computer 798 may then store the image evaluation related data in the database 777, from which it may be retrieved at a later time. The computer 701 may be operable for presenting a query to the computer 798 for input to the database 777, and for receiving corresponding replies, over the data communications network 788.

The computer 701 comprises a plurality of electronic components, each of which is coupled to a data bus 702. The data bus 702 is operable for allowing each of the multiple, various electronic components of computer 701 to exchange data signals with each of the other electronic components.

The electronic components of the computer 701 may comprise integrated circuit (IC) devices, including one or more microprocessors. The electronic components of the computer 701 may also comprise other IC devices, such as a microcontroller, field-programmable gate array (FPGA) or other programmable logic device (PLD) or application-specific IC (ASIC).

The microprocessors may comprise a central processing unit (CPU) 704. The CPU 704 is operable for performing general data processing functions related to operations of the GRUI and other components of the computer 701. The electronic components of the computer 701 may also comprise one or more other processors 744.

For example, the other microprocessors may comprise a graphics processing unit (GPU) and/or digital signal processor (DSP) 704, which are each operable for performing data processing functions that may be somewhat more specialized than the general processing functions, as well as sometimes sharing some processing functions with the CPU 704.

One of the processors 744 may also be operable as a “math” (mathematics) coprocessor. The math co-processor, DSP and/or GPU (“DSP/GPU”) 744 are operable for performing computationally intense data processing. The computationally intense processing may relate to imaging, image evaluation, graphics, dimension measurements, wireframe manipulations, coordinate system management, control, and other (e.g., mathematical, financial) information. One of the microprocessors may comprise an image processor for processing the video feed from the camera 411.

The data processing operations comprise computations performed electronically by the image processor 333, CPU 704, and the DSP/GPU 744. The microprocessors may comprise components operable as an ALU, a FPU, and associated memory cells. The memory cells comprise non-transitory data storage media, which may be configured as caches (e.g., “L1,” “L2”), registers, latches and/or buffers.

The memory cells are operable for storing data electronically in relation to various functions of the processor. A translational look-aside buffer (TLB) may be operable for optimizing efficiency of use of content-addressable memory (CAM) by the CPU 704, and/or the DSP/GPU 744, etc.

The computer 701 also comprises non-transitory computer readable storage media operable for storing data, e.g., electronically. For example, the computer readable storage media comprises a main memory 706, such as a random access memory (RAM) or other dynamic storage medium. The main memory 706 is coupled to data bus 702 for storing information and instructions, which are to be executed by the CPU 704.

The main memory 706 may also be used for storing temporary variables or other intermediate information during execution of instructions by the CPU 704. Other memories (represented in the present description with reference to the RAM 706) may be installed for similar uses by the DSP/GPU 744.

The printing evaluation system 300 further comprises a read-only memory (ROM) 708 or other static storage medium coupled to the data bus 702. The ROM 708 is operable for storing static information and instructions for use by the CPU 704. In addition to the RAM 706 and the ROM 708, the non-transitory storage media may comprise at least one data storage device 710. The data storage device 710 is operable for storing information and instructions and allowing access thereto.

The data storage device 710 may comprise a magnetic disk drive, flash drive, or optical disk drive (or other non-transitory computer readable storage medium). The data storage device 710 comprises non-transitory media coupled to data bus 702, and may be operable for providing a “virtual memory” function. The virtual memory operations of the storage device 710 may supplement, at least temporarily, storage capacity of other non-transitory media, such as the RAM 706.

The non-transitory storage media comprises instructions 783, which are stored (e.g., electronically, magnetically, optically, physically, etc.) in relation to software for programming, controlling, and/or configuring operations of the computer 701, including the GRUI 41 and the camera 411, etc. The instructions 783 may also relate to the performance of one or more steps of the methods 10, 20 and 30 (FIG.1, FIG.2, FIG.3, respectively). Further, instructions 783 may also relate to the operations of one or more other components of the control system 40, including the command generator 43, the drive logic 43, and/or the automated process/machinery 44.

Instructions, programming, software, settings, values, and configurations, etc. related to the methods 10, 20, and 30, the GRUI 41, other components of the control system 40, and other operations of the computer 701 are stored (e.g., magnetically, electronically, optically, physically, etc.) by the storage medium 710, memory, etc.

The computer 701 comprises a user-interactive touchscreen 725, which is operable as a combined display and component graphical user interface (GUI). The touchscreen 725 may comprise a liquid crystal display (LCD), which is operable for rendering images by modulating variable polarization states of an array of liquid crystal transistor components. The touchscreen 725 also comprises an interface operable for receiving haptic inputs from a user.

The haptic interface of the GUI touchscreen 725 may comprise, e.g., at least two arrays of microscopic (or transparent) conductors, each of which is insulated electrically from the other and disposed beneath a surface of the display 725 in a perpendicular orientation relative to the other. The haptic inputs comprise pressure applied to the surface of the touchscreen GUI 725, which cause corresponding local changes in electrical capacitance values proximate to the pressure application that are sensed by the conductor grids to effectuate a signal corresponding to the input.

The touchscreen GUI and display component 725 may be operable for rendering an interactive surface for receiving user inputs relating to the input receiver 417. The video feed received from the camera 411 may also be presented on the display 725.

The touchscreen GUI component 725 may be implemented operably for rendering images over a heightened (e.g., high) dynamic range (HDR), the rendering of the images may also be based on modulating a back-light unit (BLU). For example, the BLU may comprise an array of light emitting diodes (LEDs). The LCDs may be modulated according to a first signal and the LEDs of the BLU may be modulated according to a second signal. The touchscreen 725 may render an HDR image by coordinating the second modulation signal in real time, relative to the first modulation signal.

Other display technologies may also (or alternatively) be used. For example, the display 725 may comprise an organic LED (OLED) array, a display operable over a standard dynamic range (SDR), sometimes also referred to as a “low dynamic range” (LDR). The input receiver 417 may provide signals to the GRUI 41 and other components of the control system 40 and the computer 701 via the GUI 725.

An input receiver 714 may comprise one or more electromechanical switches, which may be implemented as buttons, escutcheons, microelectromechanical sensors (MEMS) or other sensors, and/or cursor controls. The inputs 714 may also comprise a keyboard. The keyboard may comprise an array of alphanumeric (and/or ideographic, syllabary based) keys operable for typing letters, number, and other symbols. The keyboard may also comprise an array of directional (e.g., “up/down,” “left/right”) keys, operable for communicating commands and data selections to the CPU 704 and for controlling movement of a cursor rendering over the touchscreen GUI display 725.

The directional keys may be operable for presenting two (2) degrees of freedom of a cursor, over at least two (2) perpendicularly disposed axes presented on the display component of the touchscreen GUI 725. A first ‘x’ axis is disposed horizontally. A second ‘y’ axis, complimentary to the first axis, is disposed vertically. Thus, the printing evaluation system 300 is thus operable for specifying positions over a representation of a geometric plane and/or other coordinate systems.

Execution of instruction sequences contained in the storage media 710 and main memory 706 cause the CPU 704 to perform processing related to general operations of the computer 701, the DSP/GPU 744 to perform various other processing operations, and the GRUI 41 and other components of the control system 40 (FIG.4) to perform processing steps related to methods 10, 20 and 30 (FIG.1, FIG.2, FIG.3, respectively). Additionally or alternatively, hard-wired circuitry may be used in place of, or in combination with the software instructions. Thus, the computer 701 is not limited to any specific combination of circuitry, hardware, firmware, or software.

The term “computer readable storage medium,” as used herein, may refer to any non-transitory storage medium that participates in providing instructions to the various processor components of the computer 701 for execution. Such a medium may take various forms including, but not limited to, non-volatile media, volatile media, and transmission media.

Non-volatile media comprises, for example, configured/programmed active elements of the GRUI 41 (and other components of the control system 40) the CPU 704, the DSP/GPU 744, the non-transitory image related media 710, stored instructions 783, and other optical, electronic, or magnetic media. Volatile media comprises dynamic memory associated, e.g., with the RAM 706.

Transmission media comprises coaxial cables, copper wire and other electrical conductors and fiber optics, including the wires (and/or other conductors or optics) that comprise the data bus 702.

Transmission media can also take the form of electromagnetic radiation (e.g., light waves), such as may be generated at a radio frequency (RF), and infrared (IR) and other optical frequencies. Data communications may also be effectuated using other means, including acoustic (e.g., sound related) or other mechanical, vibrational, or phonon related media.

Non-transitory computer-readable storage media may comprise, for example, flash drives such as may be accessible via universal serial bus (USB) or any medium from which a computer can read data.

Various forms of non-transitory computer readable storage media may be involved in carrying one or more sequences of one or more instructions to CPU 704 for execution. For example, the instructions may initially be carried on a magnetic or other disk of a remote computer (e.g., computer 798). The remote computer can load the instructions into its dynamic memory and send the instructions over networks 788.

The printing evaluation system 300 can receive the data over the network 788 and use an IR, RF or other transmitter means to convert the data to corresponding signals. An IR, RF or other signal detector or receiver (“receiver”) coupled to the data bus 702 can receive the data carried in the corresponding signals and place the data on data bus 702. The operations associated with the transmitter and the receiver may be combined in a transmitter/receiver (transceiver) means. The transmitter, receiver, and/or transceiver means may be associated with the interfaces 718.

The data bus 702 carries the data to main memory 706, from which CPU 704 and the DSP/GPU 744 retrieve and execute the instructions. The instructions received by main memory 706 may optionally be stored on storage device 710 either before or after execution by CPU 704.

The interfaces 718 may comprise a communication interface coupled to the data bus 702. The communication interface is operable for providing a two-way (or more) data communication coupling to a network link 720, which may connect wirelessly at radio frequencies (RF) to the network 788. Wireless communication may also be implemented optically, e.g., at IR frequencies.

Signals may be exchanged via the interfaces 718 with an external device 799 (e.g., another computer or external storage device) through a compatible communication port 719. The input receiver 417 may provide signals to the GRUI 41 and other components of the control system 40 and the computer 701 via the port 719.

In any implementation, the communication interface 718 sends and receives electrical, electromagnetic, or optical signals that carry digital data streams representing various types of information. The network link 720 provides data communication through the network 788 to other data devices. The input receiver 417 may provide signals to the GRUI 41 and other components of the control system 40 and the computer 701 via the network links and/or the data communications network 788.

The network 788 may use one or more of electrical, electromagnetic, and/or optical signals carrying digital data streams. The signals sent over the network 788 and through the network link 720 and communication interface 718 carry the digital data to and from the printing evaluation system 300. The printing evaluation system 300 can send messages and receive data, including program code, through the network 788, network link 720, and communication interface 718.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER′S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

Example embodiments of the present invention are thus described in relation to methods and systems for controlling industrial processes and/or machinery. An operator of the industrial process is observed by a camera. A gesture of the observed operator is recognized. A command based on the recognized gesture is generated by comparison of the recognized gesture to a database. The generated command is input to control logic operable for controlling the industrial process. A control function is exerted over the industrial process according to the command input. The industrial process is operated automatically based on the exerted control function without a touch-based operator input to a manual control device.

Example embodiments of the present invention thus provide inputs to a control system that mitigates operator exposure to hazards related to sources of high energy associated with industrial processes and machinery. An example embodiment relates to a gesture based UI operable touchlessly for inputting signals to an automated control system associated with the industrial processes and machinery, which avoids exposing the operators to the high-energy related hazards thereof. Example embodiments may be implemented that are operable for inputting the control signals independent of close proximity to the UI.

For clarity and brevity, as well as to avoid unnecessary or unhelpful obfuscating, obscuring, obstructing, or occluding features of an example embodiment, certain intricacies and details, which are known generally to artisans of ordinary skill in related technologies, may have been omitted or discussed in less than exhaustive detail. Any such omissions or discussions are unnecessary for describing example embodiments of the invention, and not particularly relevant to understanding of significant features, functions and aspects of the example embodiments described herein.

In the specification and/or figures, typical embodiments of the invention have been disclosed. The present invention is not limited to such example embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

What is claimed, is:

1. A method for programming a control over an industrial process, the programming method comprising the steps of:
establishing one or more commands, each related to an activation of a corresponding a control function over an aspect of the industrial process;
storing, in a database, a plurality of images relating to one or more gestures, which are each presentable with a particular motion of a portion of a body of one or more human operators of the industrial process;
associating, in the database, an addressable corresponding relationship between each of the gestures and a specific one of the established commands;
observing, with a camera and during an operation of the industrial process, at least one of the human operators;
sensing a movement of the portion of the body of the observed at least one operator;
querying the database in relation to the sensed movement;
recognizing, responsive to the querying, that the sensed operator body part movement corresponds to the particular motion associated with the particular established command;
asserting a controlling input to the industrial process corresponding to the recognized associated established command; and
activating the control over the industrial process based on the asserted controlling input;
wherein the activated control is imposed over the industrial process independent of an actuation exerted with zero or more manual, manual-electric, or automatic controllers operable parallel to the programming steps.

2. A method for operating an industrial process comprising the steps of:
capturing a gesture of an operator of an industrial process with a camera;
comparing the gesture to a gesture database;
determining the gesture is associated with a control function associated an industrial process based on the comparison;
identifying a command associated with the control function;
transmitting an electronic signal representative of the command to control logic operable for controlling the industrial process; and
automatically exerting the control function associated with the industrial process based on the command independent of a physical contact exertable with an action of the operator using a device configured to control the industrial process with the physical contact.

3. The method as described in claim 1 wherein one or more of the recognizing step, the generating step, the inputting step, or the exerting step relate to an operation of the industrial process.

4. The method as described in claim 3 wherein the operation of the industrial process comprises one or more of avoiding or deterring an unsafe condition related to an operation of the industrial process.

5. The method as described in claim 4 wherein the industrial process operation comprises stopping the process.

6. The method as described in claim 5 wherein one or more of the recognized gesture, the command, or the input relate to an ‘emergency stop’ signal operable for implementing the stopping of the process without an intentional delay.

7. The method as described in claim 3 wherein the operation of the industrial process relates to allowing an implementation of one or more of the generating step, the inputting step, or the exerting step to the operator based restrictively on an authority of the operator corresponding thereto.

8. The method as described in claim 7 wherein the using of the camera to recognize the gesture of the operator comprises identifying the operator.

9. The method as described in claim 8 wherein the using the camera to recognize the gesture of the operator comprises determining that the authority of the identified operator making the gesture based input comprises an allowable validity.

10. The method as described in claim 9 wherein the identifying of the operator comprises pairing, relationally, an identity of each of a plurality of authorized candidate operators and a corresponding unique authority level in relation to the controlling of the automated industrial process.

11. The method as described in claim 10 wherein the relational pairing of the identity of the unique authority level corresponding to each of the authorized candidate operators comprises querying an operator authority database in relation to the operator.

12. The method as described in claim 11 wherein the relational pairing of the identity of the unique authority level corresponding to each of the authorized candidate operators further comprises:
identifying the operator, based on the querying of the operator authority database, in relation to the plurality of authorized candidate operators;
validating that the unique authority level corresponding to the identified operator comprises, positively, the controlling of the automated industrial process; and
enabling, based on the validating step, one or more of the generating of the command, inputting of the generated command, or exerting of the control function.

13. The method as described in claim 7 further comprising inhibiting, impeding, deterring, or preventing an implementation of the one or more of the generating step, the inputting step, or the exerting step, upon a determination that the operator lacks the authority.

14. The method as described in claim 7 further comprising, upon a determination that the operator lacks the authority, triggering a corresponding indication, alert, alarm, or notice.

15. The method as described in claim 2 wherein the using of the camera to recognize the gesture of the operator of the industrial process imaged with the camera comprises:
processing an image captured with the camera in relation to the gesture of the operator; and
querying a database comprising a catalog of gestures associated with one or more inputs relating to the operating of the industrial process.

16. The method as described in claim 15 wherein one or more of the determining that the recognized gesture is associated with the implementation of a control function, or the generating of the command corresponding to the implementation of the control function is based on the querying of the catalog of gestures database.

17. The method as described in claim 16 wherein the catalog of gestures database pairs, relationally, each of a plurality of operator gestures with a corresponding particular control input.

18. The method as described in claim 2 wherein the camera is operable for generating a real time video data stream.

19. The method as described in claim 2 wherein the at least one operating function of the industrial process relates to an operation of one or more of a machine, a valve, a chemical reaction, or a combustion.

20. A method for controlling an industrial process, the method comprising the steps of:
maintaining a gesture database related to a plurality of gestures associated with one or more inputs relating to the controlling of the industrial process;
processing an image captured with a camera in relation to a motion of an operator of the industrial process;
querying the gesture database based on the processed image;
recognizing the motion of the operator as comprising one of the gestures associated with the controlling of the industrial process;
determining that the recognized gesture is associated with a control over at least one operation of the industrial process;
generating a command corresponding to the control over the at least one function of the industrial process;
inputting the generated command to control logic operable for implementing the control over the at least one function of the industrial process; and
implementing the control over the at least one function of the industrial process based on the command input;
wherein the industrial process is controlled automatically according to the implementing of the control over the at least one operating function, independent of an input exertable with an action of the operator to a touch-based manual or manual-electric control device.
